(19) United States
(12) Patent Application Publication
(10) Pub. No.: US 2024/0248257 A1
(43) Pub. Date: Jul. 25, 2024

(54) FUSION SPLICER AND V GROOVE CLEANING JIG

(71) Applicants: SUMITOMO ELECTRIC INDUSTRIES, LTD., Osaka (JP); Sumitomo Electric Optifrontier Co., Ltd., Kanagawa (JP)

(72) Inventors: Toshihiko HOMMA, Osaka (JP); Ryuichiro SATO, Kanagawa (JP)

(21) Appl. No.: 18/561,486

(22) PCT Filed: Jun. 23, 2022
(86) PCT No.: PCT/JP2022/025135

§ 371 Date: Nov. 16, 2023

(30) Foreign Application Priority Data
Jun. 29, 2021 (JP) 2021-107911

(51) Int. Cl. G02B 6/255; B08B 1/16; B08B 1/30

(52) U.S. Cl. CPC G02B 6/2555; B08B 1/165; B08B 1/30; G02B 6/2553

(57) ABSTRACT

A fusion splicer for fusion splicing an optical fiber includes a base member having a V groove in which the optical fiber is provided, wherein a stepped portion is provided on an inclined surface of the V groove, and the stepped portion is provided at a position making contact with the optical fiber.

### TECHNICAL FIELD

The present disclosure relates to fusion splicers and V groove cleaning jigs.

This application is based upon and claims priority to Japanese Patent Application No. 2021-107911, filed on Jun. 29, 2021, the entire contents of which are incorporated herein by reference.

### BACKGROUND ART

A method for positioning and fusion splicing an optical fiber that is to be connected with respect to a V groove is known (refer to Patent Document 1).

### PRIOR ART DOCUMENTS

### Patent Documents

Patent Document 1: International Publication Pamphlet No. WO 2020/162044

### DISCLOSURE OF THE INVENTION

A fusion splicer according to one embodiment of the present disclosure is a fusion splicer that fusion splices optical fibers, and includes a base member having a V groove in which the optical fiber is provided, wherein a stepped portion is provided on an inclined surface of the V groove, and the stepped portion is provided at a position making contact with the optical fiber.

### BRIEF DESCRIPTION OF THE DRAWINGS

FIG. 1 is a perspective view of a part of a fusion splicer.

FIG. 2A is a top view of a part of the fusion splicer.

FIG. 2B is a top view of a part of the fusion splicer.

FIG. 3 is a cross sectional view of a part of the fusion splicer.

FIG. 4 is a block diagram illustrating a control system that controls the fusion splicer.

FIG. 5 is a perspective view of a part of the fusion splicer.

FIG. 6A is a top view of an example of a first left V groove.

FIG. 6B is a top view of the first left V groove of FIG. 6A and a first left optical fiber.

FIG. 6C is a cross sectional view of the first left V groove of FIG. 6A and the first left optical fiber.

FIG. 6D is a top view of another example of the first left V groove of FIG. 6A.

FIG. 7A is a perspective view of a jig.

FIG. 7B is a right side view of the jig of FIG. 7A.

FIG. 7C is a right side view of another example of the jig of FIG. 7A.

FIG. 7D is a right side view of still another example of the jig of FIG. 7A.

FIG. 8A is a top view of another example of the first left V groove.

FIG. 8B is a top view of the first left V groove of FIG. 8A and the first left optical fiber.

FIG. 8C is a cross sectional view of the first left V groove of FIG. 8A and the first left optical fiber.

FIG. 8D is a top view of another example of the first left V groove of FIG. 8A.

FIG. 8E is a top view of still another example of the first left V groove of FIG. 8A.

FIG. 9A is a top view of still another example of the first left V groove.

FIG. 9B is a top view of the first left V groove of FIG. 9A and the first left optical fiber.

FIG. 9C is a cross sectional view of the first left V groove of FIG. 9A and the first left optical fiber.

FIG. 10A is a top view of still another example of the first left V groove.

FIG. 10B is a top view of the first left V groove of FIG. 10A and the first left optical fiber.

FIG. 10C is a cross sectional view of the first left V groove of FIG. 10A and the first left optical fiber.

FIG. 11A is a top view of still another example of the first left V groove.

FIG. 11B is a top view of the first left V groove of FIG. 11A and the first left optical fiber.

FIG. 11C is a cross sectional view of the first left V groove of FIG. 11A and the first left optical fiber.

FIG. 12A is a top view of still another example of the first left V groove.

FIG. 12B is a cross sectional view of the first left V groove of FIG. 12A.

FIG. 12C is a top view of another example of the first left V groove of FIG. 12A.

### MODE OF CARRYING OUT THE INVENTION

### Problem to be Solved by the Present Disclosure

Patent Document 1 describes a method for removing foreign matter adhered between an optical fiber and a V groove. However, in this method, it is necessary to perform an operation for positively removing the foreign matter, in addition to a normal fusion splicing operation. Hence, it is desirable to minimize the additional operation for removing the foreign matter.

### Effects of the Present Disclosure

The fusion splicer described above can reduce the additional operation for removing foreign matter.

### DESCRIPTION OF EMBODIMENTS OF THE PRESENT DISCLOSURE

First, embodiments of the present disclosure will be described in the following.

(1) A fusion splicer according to one embodiment of the present disclosure is a fusion splicer for fusion splicing an optical fiber, including a base member having a V groove in which the optical fiber is provided, wherein a stepped portion is provided on an inclined surface of the V groove, and the stepped portion may be provided at a position making contact with the optical fiber. In this configuration, by reducing a surface area of a part of the inclined surface (groove surface) of the V groove making contact with the optical fiber, it is possible to reduce a probability of foreign matter adhering to the portion making contact. For this reason, this configuration can achieve the effect of reducing foreign matter becoming caught between the optical fiber and the V groove when providing the optical fiber in the V groove. Further, this configuration can achieve the effect of accurately positioning the optical fiber inside the V groove. The portion of the optical fiber provided in the V groove is a portion where a coating material is removed and a glass fiber is exposed, and is also referred to as a bare fiber portion. In addition, the portion coated with the coating material is also referred to as an optical fiber element wire or an optical fiber core.

(2) A fusion splicer according to one embodiment of the present disclosure is a fusion splicer for fusion splicing an optical fiber, including a base member having a V groove in which the optical fiber is provided, wherein a stepped portion is provided on an inclined surface of the V groove, and the stepped portion may be a recess provided at a bottom portion of the V groove. In this configuration, because there is a region where foreign matter is accumulated at the bottom portion of the V groove, it is possible to achieve the effect of reducing the foreign matter becoming caught between the optical fiber and the V groove when providing the optical fiber in the V groove. Further, this configuration can achieve the effect of accurately positioning the optical fiber inside the V groove.

(3) The recess may be a through hole penetrating the base member. This configuration enables the foreign matter entering into the V groove to be discharged outside the V groove through the through hole. For this reason, this configuration can achieve the effect of reducing the foreign matter becoming caught between the optical fiber and the V groove when providing the optical fiber in the V groove. Further, this configuration can achieve the effect of accurately positioning the optical fiber inside the V groove.

(4) The optical fiber may be a plurality of optical fibers, and the V groove may be a plurality of V grooves in which the plurality of optical fibers are provided. In this case, the stepped portion is provided in at least one of the plurality of V grooves. In this configuration, even if the optical fiber is one of the plurality of optical fibers forming a multicore optical fiber ribbon, for example, it is possible to achieve the effect of reducing the foreign matter becoming caught between the optical fiber and the V groove when providing the optical fiber in the V groove. Further, this configuration can achieve the effect of accurately positioning the optical fiber inside the V groove.

(5) A V groove cleaning jig according to one embodiment of the present disclosure, used for cleaning the V groove in the fusion splicer, may include a sliding surface that forms a part of the inclined surface and makes contact with a supporting surface supporting the optical fiber. The V groove is cleaned to remove foreign matter adhered to the groove surface of the V groove, for example. In this case, the V groove cleaning jig may be configured to be slidable in an extending direction of the V groove in a state where the supporting surface and the sliding surface make contact with each other. The support surface may be a surface that makes contact with the optical fiber to support the optical fiber. The V groove cleaning jig can scrape off the foreign matter adhered to the support surface from the support surface before the optical fiber is provided in the V groove. For this reason, when the optical fiber is provided in the V groove, it is possible to achieve the effect of reducing the foreign matter becoming caught between the optical fiber and the V groove when providing the optical fiber in the V groove. Further, the V groove cleaning jig can achieve the effect of accurately positioning the optical fiber inside the V groove.

### DETAILS OF EMBODIMENTS OF THE PRESENT DISCLOSURE

Hereinafter, specific examples of a fusion splicer 1 and an optical fiber splicing method according to one embodiment of the present disclosure will be described, with reference to the accompanying drawings.

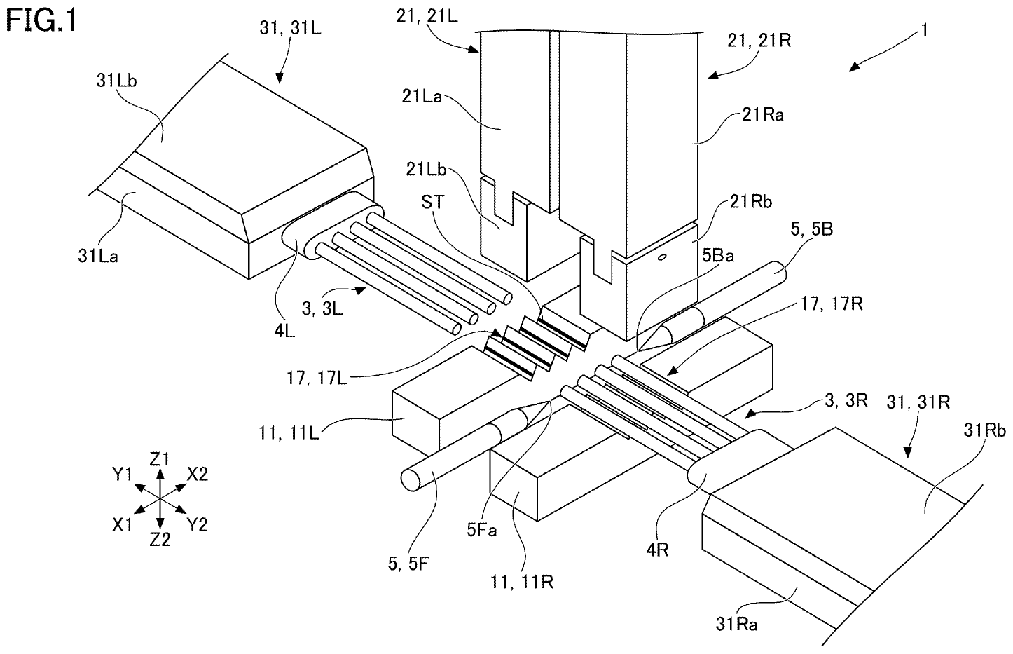

FIG. 1 is a perspective view illustrating a part of the fusion splicer 1. In FIG. 1, X1 represents one direction of an X-axis forming a three dimensional orthogonal coordinate system, and X2 represents the other direction of the X-axis. Y1 represents one direction of a Y-axis forming the three dimensional orthogonal coordinate system, and Y2 represents the other direction of the Y-axis. Similarly, Z1 represents one direction of a Z-axis forming the three dimensional orthogonal coordinate system, and Z2 represents the other direction of the Z-axis. In the present embodiment, the X1 side of the fusion splicer 1 corresponds to a front side (front surface side) of the fusion splicer 1, and the X2 side of the fusion splicer 1 corresponds to a rear side (rear surface side) of the fusion splicer 1. The Y1 side of the fusion splicer 1 corresponds to a left side of the fusion splicer 1, and the Y2 side of the fusion splicer 1 corresponds to a right side of the fusion splicer 1. The Z1 side of the fusion splicer 1 corresponds to an upper side of the fusion splicer 1, and the Z2 side of the fusion splicer 1 corresponds to a lower side of the fusion splicer 1. The same applies to other figures.

The fusion splicer 1 is a device configured to be able to fusion splice a plurality of optical fiber pairs arranged with end surfaces thereof butted against each other, using arc discharge. In the illustrated example, the fusion splicer 1 is configured to be able to fusion splice four optical fiber pairs. In particular, the fusion splicer 1 includes a pair of electrodes 5 (a rear electrode 5B and a front electrode 5F), a pair of base members 11 (a left base member 11L and a right base member 11R), a pair of clamps 21 (a left clamp 21L and a right clamp 21R), and a pair of fiber holders 31 (a left fiber holder 31L and a right fiber holder 31R).

The pair of electrodes 5 includes the rear electrode 5B and the front electrode 5F disposed to be spaced apart from each other in the X-axis direction. The pair of electrodes 5 is disposed so that a tip end 5Ba of the rear electrode 5B and a tip end 5Fa of the front electrode 5F oppose each other. In the illustrated example, the rear electrode 5B includes a conical portion having a diameter that decreases toward the tip end 5Ba. The same applies to the front electrode 5F.

The plurality of optical fiber pairs disposed on the pair of base members 11 are glass fibers, and are disposed between the rear electrode 5B and the front electrode 5F for generating arc discharge. In addition, among the plurality of optical fiber pairs, portions provided on the pair of base members 11 are bare fiber portions where a coating material is removed and the glass fiber is exposed.

In particular, the plurality of pairs of bare fiber portions include a bare fiber portion of a left optical fiber group 3L forming a left optical fiber ribbon 4L, and a bare fiber portion of a right optical fiber group 3R forming a right optical fiber ribbon 4R. Hereinafter, the left optical fiber group 3L and the right optical fiber group 3R may be referred to as an optical fiber group 3 for the sake of convenience.

A optical fiber ribbon is formed by arranging a plurality of optical fibers (optical fiber element wires) in parallel and collectively coating the plurality of optical fibers with an ultraviolet curable resin (coating material), for example. Each of the left optical fiber ribbon 4L and the right optical fiber ribbon 4R in the illustrated example is a four-core optical fiber ribbon in which four optical fibers (optical fiber element wires) are arranged in parallel and collectively coated with the ultraviolet curable resin (coating material).

The pair of base members 11 is a member for supporting the plurality of optical fiber pairs, and includes a left base member 11L and a right base member 11R that are disposed so as to sandwich the pair of electrodes 5. In other words, the pair of electrodes 5 is disposed between the left base member 11L and the right base member 11R that are spaced apart from each other in the Y-axis direction. The right base member 11R of the illustrated example has a right V groove group 17R, also referred to as a right optical fiber placement portion or a right groove portion, and the left base member 11L has a left V groove group 17L, also referred to as a left optical fiber placement portion or a left groove portion. Hereinafter, the left V groove group 17L and the right V groove group 17R may be referred to as a V groove group 17 for the sake of convenience.

The left V groove group 17L has a plurality of V grooves for arranging a plurality of optical fibers (left optical fiber group 3L) therein, and the right V groove group 17R has a plurality of V grooves for arranging a plurality of optical fibers (right optical fiber group 3R) therein. In the illustrated example, the left V groove group 17L has four V grooves for arranging four optical fibers therein. The four V grooves are arranged at equal intervals in the X-axis direction, and are formed to linearly extend along the Y-axis direction. Similarly, the right V groove group 17R has four V grooves for arranging four optical fibers therein. The four V grooves are arranged at equal intervals in the X-axis direction, and are formed to linearly extend along the Y-axis direction.

The plurality of V grooves in the right V groove group 17R and the plurality of V grooves in the left V groove group 17L are configured, so that the plurality of optical fiber pairs are positioned simultaneously. In the illustrated example, the four V grooves of the right V groove group 17R and the four V grooves of the left V groove group 17L are disposed so as to oppose each other in the extending direction (Y-axis direction), and are configured so that positioning of the four optical fiber pairs is performed simultaneously.

Hence, the four optical fibers positioned by the four V grooves of the right V groove group 17R, and the four optical fibers positioned by the four V grooves of the left V groove group 17L, are butted against each other in a region between the right base member 11R (right V groove group 17R) and the left base member 11L (left V groove group 17L).

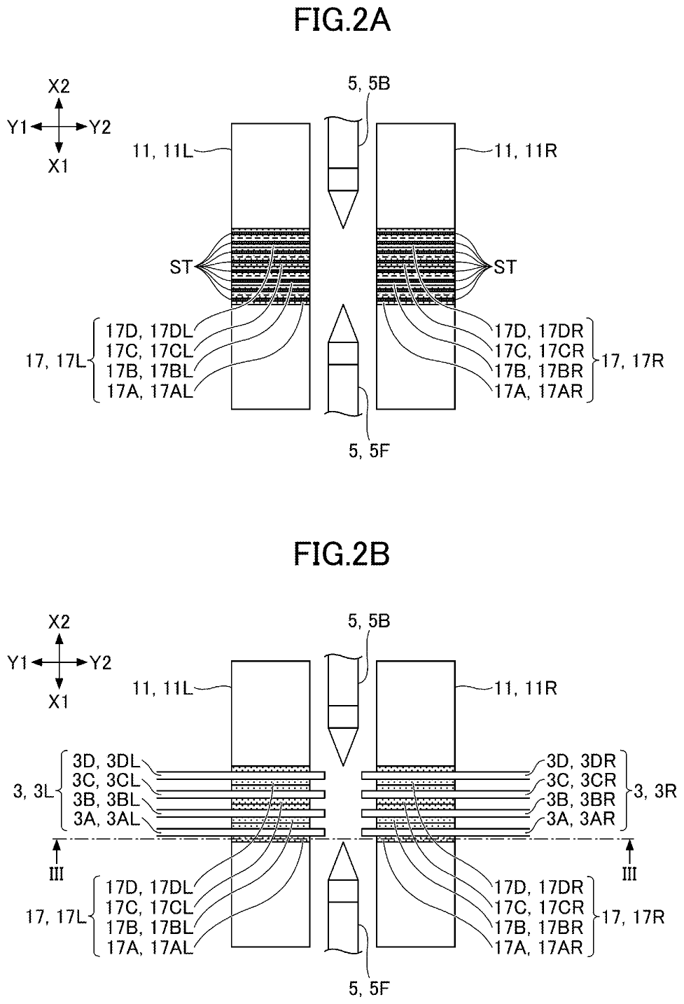

Next, details of the V groove group 17 in which the four optical fiber pairs are positioned, will be described with reference to the FIG. 2A and FIG. 2B. FIG. 2A and FIG. 2B are top views illustrating a part of the fusion splicer 1. In particular, FIG. 2A and FIG. 2B are top views of the electrodes 5 and the base members 11. More particularly, FIG. 2A illustrates a state before the optical fiber group 3 is provided in the V groove group 17, and FIG. 2B illustrates a state after the optical fiber group 3 is provided in the V groove group 17. In FIG. 2A and FIG. 2B, coarse dot patterns are added to groove surfaces of the V groove group 17, for the sake of clarity. In FIG. 2A, a bottom portion of each V groove is represented by a broken line.

As illustrated in the FIG. 2A, the left V groove group 17L includes a first left V groove 17AL, a second left V groove 17BL, a third left V groove 17CL, and a fourth left V groove 17DL, and the right V groove group 17R includes a first right V groove 17AR, a second right V groove 17BR, a third right V groove 17CR, and a fourth right V groove 17DR. Further, the first left V groove 17AL and the first right V groove 17AR form a first V groove pair 17A, the second left V groove 17BL and the second right V groove 17BR form a second V groove pair 17B, the third left V groove 17CL and the third right V groove 17CR form a third V groove pair 17C, and the fourth left V groove 17DL and the fourth right V groove 17DR form a fourth V groove pair 17D.

In addition, as illustrated in the FIG. 2B, the left optical fiber group 3L includes a first left optical fiber 3AL, a second left optical fiber 3BL, a third left optical fiber 3CL, and a fourth left optical fiber 3DL as bare fiber portions, and the right optical fiber group 3R includes a first right optical fiber 3AR, a second right optical fiber 3BR, a third right optical fiber 3CR, and a fourth right optical fiber 3DR as bare fiber portions. The first left optical fiber 3AL and the first right optical fiber 3AR form a first optical fiber pair 3A, the second left optical fiber 3BL and the second right optical fiber 3BR form a second optical fiber pair 3B, the third left optical fiber 3CL and the third right optical fiber 3CR form a third optical fiber pair 3C, and the fourth left optical fiber 3DL and the fourth right optical fiber 3DR form a fourth optical fiber pair 3D.

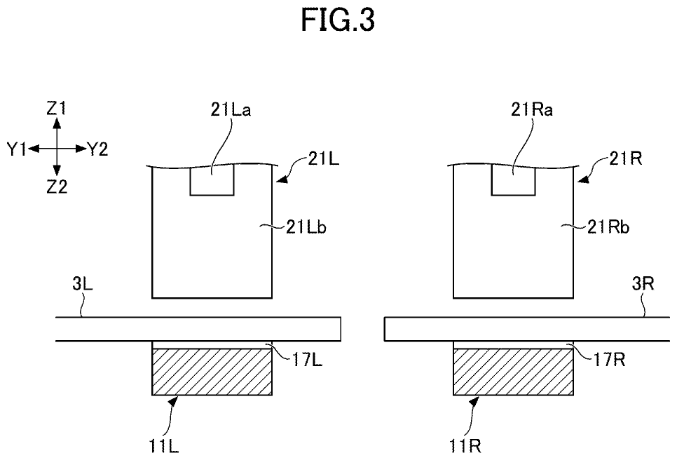

Next, movements of the pair of clamps 21 (a left clamp 21L and a right clamp 21R) will be described, with reference to FIG. 3. FIG. 3 is a cross sectional view illustrating a part of the fusion splicer 1. In particular, FIG. 3 is a cross sectional view along a line III-III in FIG. 2B viewed from the X1 side as indicated by arrows. The cross section of FIG. 2B includes a cross section of the base member 11.

The left clamp 21L is configured to be able to press the left optical fiber group 3L provided in the left V groove group 17L against and relative to the left V groove group 17L. Similarly, the right clamp 21R is configured to be able to press the right optical fiber group 3R provided in the right V groove group 17R against and relative to the right V groove group 17R. In the illustrated example, the left clamp 21L includes a left arm portion 21La and a left pressing portion 21Lb, and the right clamp 21R includes a right arm portion 21Ra and a right pressing portion 21Rb. The left arm portion 21La is disposed above the left V groove group 17L, and the right arm portion 21Ra is disposed above the right V groove group 17R. Moreover, the left arm portion 21La and the right arm portion 21Ra are configured to be movable in the Z-axis direction. The left arm portion 21La and the right arm portion 21Ra may have an external shape that is a rectangular column shape as illustrated in FIG. 1, for example. Further, the left pressing portion 21Lb may be attached to a lower end of the left arm portion 21La, and the right pressing portion 21Rb may be attached to a lower end of the right arm portion 21Ra. In the illustrated example, the left pressing portion 21Lb is movable in the Z-axis direction at the lower end of the left arm portion 21La, and the right pressing portion 21Rb is movable in the Z-axis direction at the lower end of the right arm portion 21Ra. In a state illustrated in FIG. 3, the left pressing portion 21Lb is separated from the left optical fiber group 3L provided in the left V groove group 17L, but the left pressing portion 21Lb can make contact with the left optical fiber group 3L and press the left optical fiber group 3L toward the left V groove group 17L by moving the left arm portion 21La downward. The same applies to the right pressing portion 21Rb.

Moreover, in the illustrated example, the left clamp 21L may be configured so that a clamp pressure is variable. The clamp pressure is a pressure that is received by the left optical fiber group 3L provided in the left V groove group 17L from the left pressing portion 21Lb of the left clamp 21L. An elastic body, such as a spring or the like, configured to urge the left pressing portion 21Lb downward, may be disposed between the left arm portion 21La and the left pressing portion 21Lb. In this case, the left clamp 21L can control the clamp pressure by controlling the position of the left arm portion 21La in the Z-axis direction. The same applies to the right clamp 21R.

In addition, as illustrated in FIG. 1, the left fiber holder 31L is configured to be able to hold the left optical fiber group 3L, and the right fiber holder 31R is configured to be able to hold the right optical fiber group 3R. Particularly, the left fiber holder 31L is configured to be able to hold the left optical fiber ribbon 4L including the left optical fiber group 3L, and the right fiber holder 31R is configured to hold the right optical fiber ribbon 4R including the right optical fiber group 3R. More particularly, the left fiber holder 31L has a left fiber holder body 31La that includes a recess (not illustrated.) for accommodating the left optical fiber ribbon 4L, and a left lid 31Lb attached to the left fiber holder body 31La. Similarly, the right fiber holder 31R has a right fiber holder body 31Ra that includes a recess (not illustrated.) for accommodating the right optical fiber ribbon 4R, and a right lid 31Rb attached to the right fiber holder body 31Ra.

The left optical fiber ribbon 4L is held in the left fiber holder 31L, by closing the left lid 31Lb in a state where the left optical fiber ribbon 4L is accommodated in the left fiber holder body 31La. The left fiber holder 31L is movable along an axial direction of the held left optical fiber group 3L. That is, the left fiber holder 31L is movable along a direction (Y-axis direction) in which the left V groove group 17L extends. In a case where the left fiber holder 31L holding the left optical fiber group 3L moves, the held left optical fiber group 3L can move along the left V groove group 17L.

Similarly, the right optical fiber ribbon 4R is held in the right fiber holder 31R, by closing the right lid 31Rb in a state where the right optical fiber ribbon 4R is accommodated in the right fiber holder body 31Ra. The right fiber holder 31R is movable along an axial direction of the held right optical fiber group 3R. That is, the right fiber holder 31R is movable along a direction (Y-axis direction) in which the right V groove group 17R extends. In a case where the right fiber holder 31R holding the right optical fiber group 3R moves, the held right optical fiber group 3R can move along the right V groove group 17R.

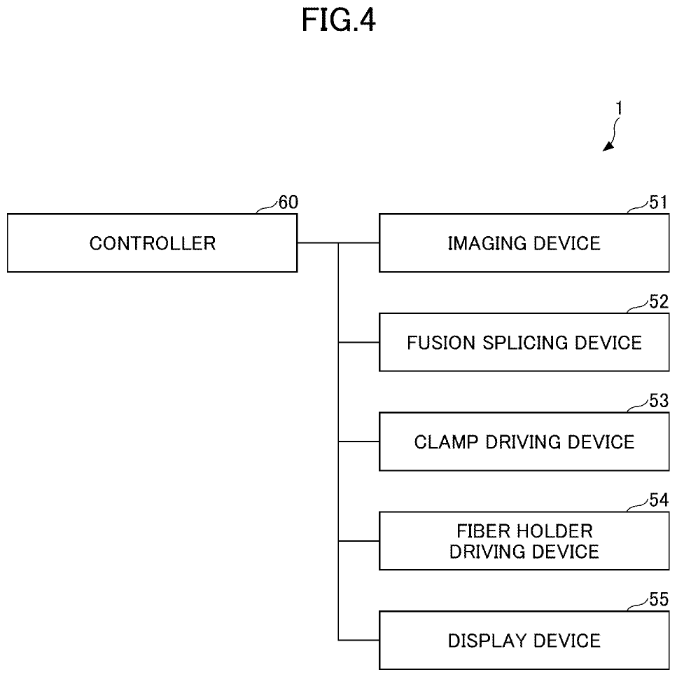

Next, a control system for controlling the fusion splicer 1 will be described, with reference to FIG. 4. FIG. 4 is a block diagram illustrating the control system for controlling the fusion splicer 1.

As illustrated in FIG. 4, the fusion splicer 1 includes an imaging device 51, a fusion splicing device 52, a clamp driving device 53, a fiber holder driving device 54, a display device 55, and a controller 60. In the present embodiment, the imaging device 51, the fusion splicing device 52, the clamp driving device 53, the fiber holder driving device 54, and the display device 55 are controlled by the controller 60.

The controller 60 is a computer including a central processing unit (CPU), a random access memory (RAM), a read only memory (ROM), a communication module, an external storage device, or the like, for example.

The imaging device 51 includes a pair of cameras (an X camera and a Y camera), for example. The X camera and the Y camera are both disposed so as to be able to simultaneously capture images of an end portion of the left optical fiber group 3L provided in the left V groove group 17L and an end portion of the right optical fiber group 3R provided in the right V groove group 17R. Further, an imaging direction of the X camera and an imaging direction of the Y camera are perpendicular to each other. The controller 60 can identify the position of the optical fiber group 3, based on the images of the optical fiber group 3 captured from two different directions by the pair of cameras.

The fusion splicing device 52 is a device for fusion splicing the end portion of the left optical fiber group 3L and the end portion of the right optical fiber group 3R. In the present embodiment, the pair of electrodes 5 is included in the fusion splicing device 52.

The clamp driving device 53 is a device for pressing the optical fiber group 3 against and relative to the V groove group 17. In the present embodiment, the clamp driving device 53 includes actuators configured to move the left arm portion 21La forming the left clamp 21L and the right arm portion 21Ra forming the right clamp 21R in the Z-axis direction, respectively.

The fiber holder driving device 54 is a device for moving the optical fiber group 3 in a direction along the axial direction (Y-axis direction). In the present embodiment, the fiber holder driving device 54 includes an actuator configured to move the left fiber holder 31L in a direction along the axial direction (Y-axis direction) of the left optical fiber group 3L, and an actuator configured to move the right fiber holder 31R in a direction along the axial direction (Y-axis direction) of the right optical fiber group 3R.

The display device 55 is a device for displaying various kinds of information. In the present embodiment, the display device 55 is configured to display an image captured by the imaging device 51. In the present embodiment, the display device 55 is a liquid crystal display.

The controller 60 is a device for controlling each of the imaging device 51, the fusion splicing device 52, the clamp driving device 53, the fiber holder driving device 54, and the display device 55. In the present embodiment, the controller 60 acquires the image captured by the imaging device 51 by controlling the imaging device 51. The controller 60 can cause the display device 55 to display the acquired image, for example. In addition, the controller 60 can determine a state of one or a plurality of optical fiber pairs by performing an image processing on the acquired image. Moreover, the controller 60 can generate an arc discharge between the rear electrode 5B and the front electrode 5F by controlling the fusion splicing device 52. Further, the controller 60 can move the left arm portion 21La of the left clamp 21L and the right arm portion 21Ra of the right clamp 21R in the Z-axis direction, by controlling the clamp driving device 53. Under the control of the controller 60, the left clamp 21L can vary the pressing state of the left optical fiber group 3L disposed in the left V groove group 17L, and the right clamp 21R can vary the pressing state of the right optical fiber group 3R disposed in the right V groove group 17R. In addition, the controller 60 can control the positions of the left fiber holder 31L and the right fiber holder 31R in the Y-axis direction, by controlling the fiber holder driving device 54. In particular, the controller 60 can move the left optical fiber group 3L held by the left fiber holder 31L in the Y-axis direction by moving the left fiber holder 31L in the Y-axis direction, and can move the right optical fiber group 3R held by the right fiber holder 31R in the Y-axis direction by moving the right fiber holder 31R in the Y-axis direction.

As described above, the V groove group 17 is used for positioning the optical fiber group 3 to be fusion spliced, however, if foreign matter is adhered inside the V groove, it may not be possible to accurately position the optical fiber group 3.

FIG. 5 illustrates an example of a state of the optical fiber when a foreign substance is present in the V groove. In particular, for the sake of clarity, FIG. 5 illustrates a state of the first left optical fiber 3AL provided in the first left V groove 17AL when an extremely large foreign matter G is adhered inside the first left V groove 17AL, and a state of the first right optical fiber 3AR provided in the first right V groove 17AR when no foreign matter is adhered inside the first right V groove 17AR.

As illustrated in FIG. 5, in the case where the foreign matter G is adhered to the tip end portion (end portion on the Y2 side) of the first left V groove 17AL, the tip end portion (end portion on the Y2 side) of the first left optical fiber 3AL becomes inclined upward. In this case, a difference is generated between the axial direction of the first left optical fiber 3AL and the axial direction of the first right optical fiber 3AR, and the fusion splicer 1 cannot appropriately fusion splice the first left optical fiber 3AL and the first right optical fiber 3AR. A typical size of the foreign matter actually adhered inside the V groove is smaller than the size of the foreign matter G illustrated in FIG. 5. However, an appropriate fusion splicing is still prevented from being performed, even in the case where the foreign matter has such a small size.

Accordingly, a stepped portion ST is formed in each of the V groove groups 17 of the fusion splicer 1 according to the present embodiment.

The stepped portion ST is a portion (structure) formed inside the V groove. In the present embodiment, the stepped portion ST is a structure that is formed to make it more difficult for foreign matter to adhere to a portion of the groove surface of the V groove that is expected to make contact with the optical fiber.

In the examples illustrated in FIG. 1, FIG. 2A, and FIG. 2B, the stepped portions ST are convex structures formed on the groove surfaces of the V grooves, and are configured to make contact with the optical fibers when the optical fibers are provided in the V grooves.

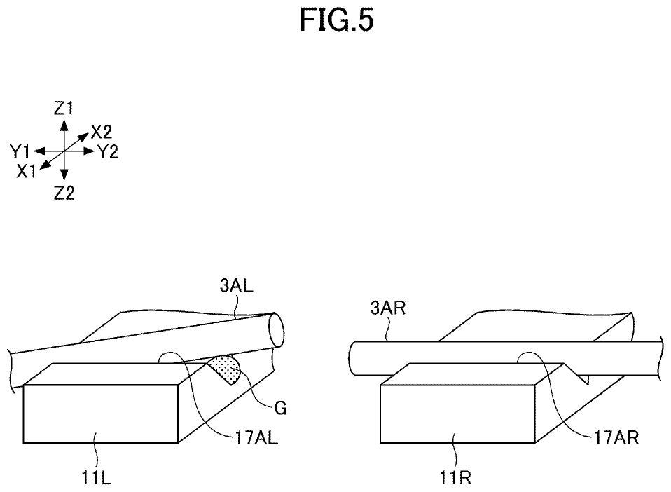

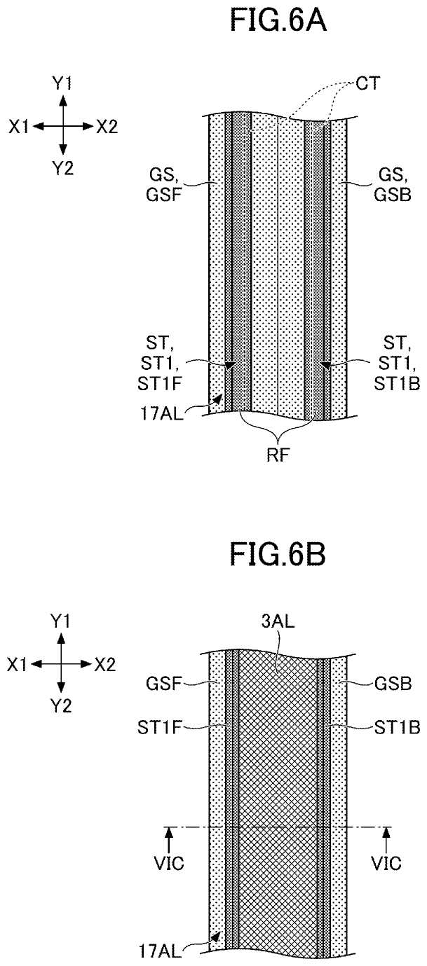

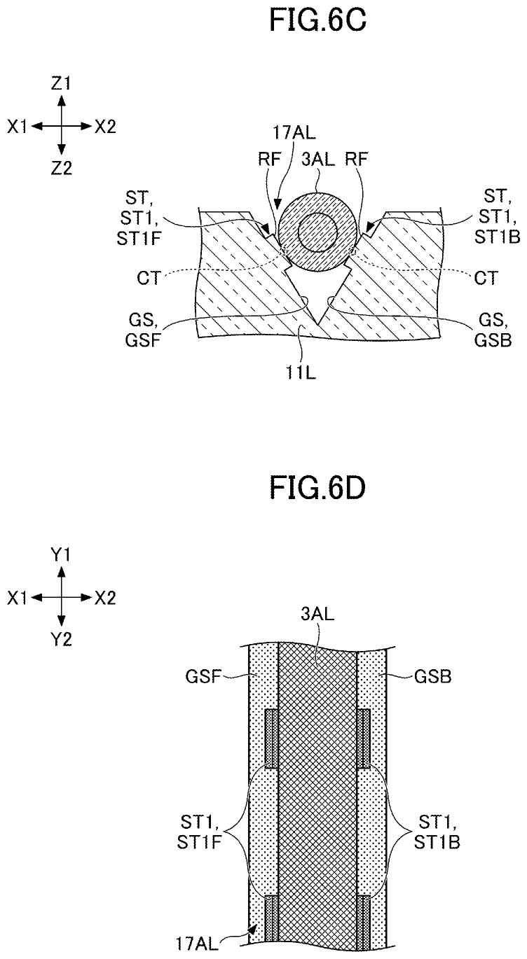

Next, a configuration example of the stepped portion ST will be described, with reference to FIG. 6A through FIG. 6D. FIG. 6A through FIG. 6D are diagrams illustrating a configuration example of the first left V groove 17AL. In particular, FIG. 6A is a top view of the first left V groove 17AL before the first left optical fiber 3AL is provided. FIG. 6B is a top view of the first left V groove 17AL after the first left optical fiber 3AL is provided. FIG. 6C is a view of a cross section including a cutting plane line VIC-VIC in FIG. 6B viewed from the Y2 side as indicated by arrows. FIG. 6D is a top view of the first left V groove 17AL including another configuration example of the stepped portion ST. In FIG. 6A, FIG. 6B, and FIG. 6D, coarse dot patterns are added to groove surfaces GS, and fine dot patterns are added to the stepped portions ST formed on the groove surfaces GS, for the sake of clarity. In addition, in FIG. 6B and FIG. 6D, cross patterns are added to the first left optical fiber 3AL, for the sake of clarity.

The following description with reference to FIG. 6A through FIG. 6D relates to the stepped portions ST formed in the first left V groove 17AL, but the description is similarly applicable to the stepped portions ST formed in each of the second left V groove 17BL through the fourth left V groove 17DL, and the first right V groove 17AR through the fourth right V groove 17DR.

FIG. 6A through FIG. 6C illustrate presser guides ST1, which are an example of the stepped portions ST. The presser guides ST1 are portions that press and hold the optical fiber from both sides inside the V groove, and guide the optical fiber along the extending direction of the V groove. In particular, the presser guide ST1 includes a front presser guide STIF formed on a front groove surface GSF of the first left V groove 17AL, and a rear presser guide STIB formed on a rear groove surface GSB of the first left V groove 17AL.

The front presser guide STIF has a rectangular cross section as illustrated in FIG. 6C, and is formed to extend continuously over the entire length of the first left V groove 17AL as illustrated in the FIG. 6A. The same applies to the rear side presser guide ST1B.

According to this configuration, support surfaces RF, including contact portions CT (portions indicated by broken lines in FIG. 6A and FIG. 6C) where the first left optical fiber 3AL and the presser guides ST1 make contact with one another, protrude from the groove surfaces GS, thereby achieving the effect of making it more difficult for the foreign matter to adhere to the support surfaces RF. This is because a surface area of the support surface RF is smaller than a surface area of the groove surface GS without the presser guide ST1.

The presser guides ST1 may be intermittently arranged along the axial direction of the first left V groove 17AL, as illustrated in FIG. 6D. According to this configuration, because the surface area of the support surface RF can further be reduced, it is possible to further reduce adhesion of the foreign matter onto the support surfaces RF.

The presser guides ST1 are formed to have a rectangular cross section as illustrated in FIG. 6C, but may have other cross sectional shapes, such as a trapezoidal shape or the like.

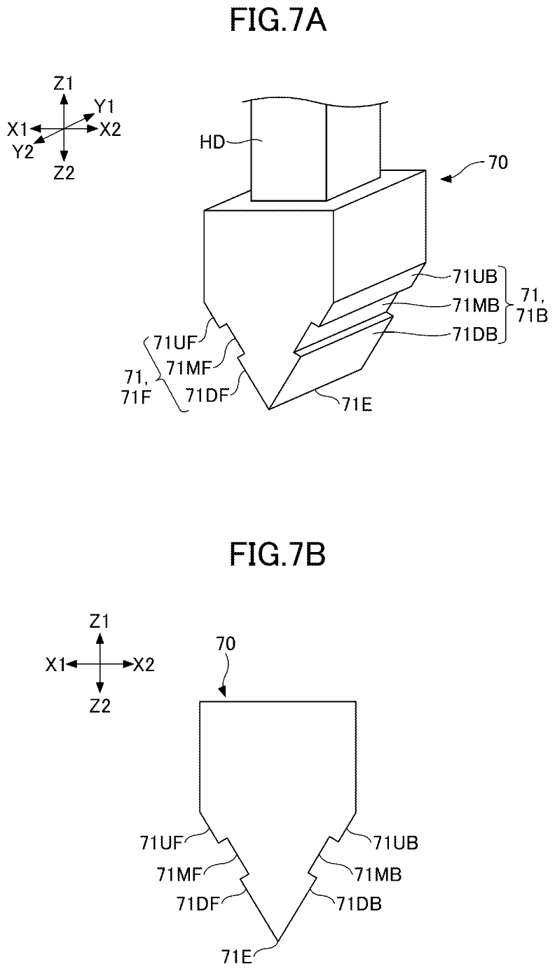

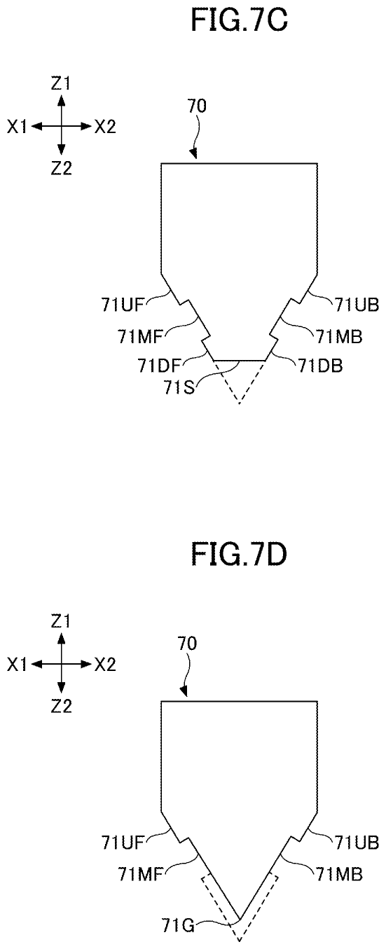

Next, a jig 70 for cleaning the V groove will be described, with reference to FIG. 7A through FIG. 7D. FIG. 7A through FIG. 7D are diagrams illustrating configuration examples of the jig 70. In particular, FIG. 7A is a perspective view of the jig 70, and FIG. 7B is a right side view of the jig 70. Moreover, FIG. 7C is a right side view of another configuration example of the jig 70, and FIG. 7D is a right side view of still another configuration example of the jig 70.

The jig 70 is a jig that is used when cleaning the V groove having the groove surfaces formed with the presser guides ST1 illustrated from FIG. 6A through FIG. 6D. In the example illustrated in FIG. 7A, an operator can cause sliding surfaces 71 of the jig 70 to make contact with the groove surfaces GS of the V grooves, while gripping a grip portion HD. In the following description, the jig 70 is used to clean the first left V groove 17AL, but the jig 70 can be used similarly to clean each of the second left V groove 17BL through the fourth left V groove 17DL, and the first right V groove 17AR through the fourth right V groove 17DR.

In the example illustrated in FIG. 7A and FIG. 7B, the jig 70 has the sliding surfaces 71 configured to make contact with the groove surfaces GS of the first left V groove 17AL.

In particular, the sliding surface 71 includes a front sliding surface 71F that is formed to make contact with the front groove surface GSF (refer to FIG. 6C), and a rear sliding surface 71B that is formed to make contact with the rear groove surface GSB (refer to FIG. 6C).

More particularly, the front sliding surface 71F includes a central sliding surface 71MF that is formed to make contact with the support surface RF of the front presser guide STIF, an upper sliding surface 71UF that is formed to make contact with a portion of the front groove surface GSF located above the front presser guide STIF, and a lower sliding surface 71DF that is formed to make contact with a portion of the front groove surface GSF located below the front presser guide ST1F.

Similarly, the rear sliding surface 71B includes a central sliding surface 71MB that is formed to make contact with the support surface RF of the rear presser guide ST1B, an upper sliding surface 71UB that is formed to make contact with a portion of the rear groove surface GSB above the rear presser guide ST1B, and a lower sliding surface 71DB that is formed to make contact with a portion of the rear groove surface GSB below the rear presser guide ST1B.

Further, the sliding surface 71 includes a tip end portion 71E that is formed to make contact with a bottom portion of the first left V groove 17AL, at a portion where the front sliding surface 71F and the rear sliding surface 71B make contact with each other.

The jig 70 is fitted into the first left V groove 17AL from the Y1 side or the Y2 side of the first left V groove 17AL, so that the sliding surfaces 71 make surface contact with the groove surfaces GS of the first left V groove 17AL. Then, the jig 70 is caused to slide in the extending direction (Y-axis direction) of the first left V groove 17AL, in a state where the sliding surfaces 71 and the groove surfaces GS of the first left V groove 17AL make surface contact with one another.

According to this configuration, the jig 70 can scrape off the foreign matter adhered to the groove surfaces GS of the first left V groove 17AL, and push out the scraped off foreign matter to an outside of the first left V groove 17AL.

Moreover, in the example illustrated in FIG. 7A and FIG. 7B, contours (refer to FIG. 7B) of the sliding surfaces 71 of the jig 70, and contours (refer to FIG. 6C) of the groove surfaces GS of the first left V groove 17AL, coincide in the right side view. For this reason, the jig 70 can scrape off or push out not only the foreign matter adhered to each of the upper end surface and the lower end surface of the front presser guide STIF, but also the foreign matter adhered to the bottom portion of the first left V groove 17AL.

However, the jig 70 may be configured to have contours illustrated in FIG. 7C or FIG. 7D. In FIG. 7C and FIG. 7D, the contours of the jig 70 in FIG. 7B are indicated by broken lines for the sake of comparison.

The jig 70 illustrated in FIG. 7C differs from the jig 70 illustrated in FIG. 7B in that the tip end portion 71E is omitted. In particular, the jig 70 illustrated in FIG. 7C differs from the jig 70 illustrated in the FIG. 71B in that the jig 70 has a bottom surface 71S that connects a lower end portion of the lower sliding surface 71DF of the front sliding surface 71F and a lower end portion of the lower sliding surface 71DB of the rear sliding surface 71B to each other.

According to this configuration, the jig 70 illustrated in FIG. 7C can achieve the effect of enabling collection of the scraped off foreign matter (foreign matter adhered to the support surfaces RF, for example) at the bottom portion of the first left V groove 17AL.

The jig 70 illustrated in FIG. 7D differs from the jig 70 illustrated in FIG. 7B in that the lower sliding surface 71DF of the front sliding surface 71F and the lower sliding surface 71DB of the rear sliding surface 71B are omitted. In particular, the jig 70 illustrated in FIG. 7D differs from the jig 70 illustrated in FIG. 7B in that the central sliding surface 71MF of the front sliding surface 71F and the central sliding surface 71 MB of the rear sliding surface 71B make contact with each other at a tip end portion 71G.

According to this configuration, the jig 70 illustrated in FIG. 7D can achieve the effect of enabling the sliding surfaces 71 to make contact with the support surfaces RF formed on the groove surfaces GS of the first left V groove 17AL, even from directly above the first left V groove 17AL. That is, the jig 70 illustrated in FIG. 7D achieves the effect of enabling the sliding surfaces 71 to more easily make contact with the support surfaces RF.

In the examples illustrated in FIG. 7A through FIG. 7D, the jig 70 is configured to be able to clean one V groove. However, the jig 70 may be configured to include an arrangement of a number of approximately convex sliding surfaces 71 equal to the number of V grooves, so as to be able to clean a plurality of V grooves simultaneously.

In addition, in the examples illustrated in FIG. 7A through FIG. 7D, the jig 70 is configured so that the sliding surfaces 71 make contact with the groove surfaces GS and the support surfaces RF, respectively, however, the jig 70 may be configured so that the sliding surfaces 71 make contact with only the support surfaces RF.

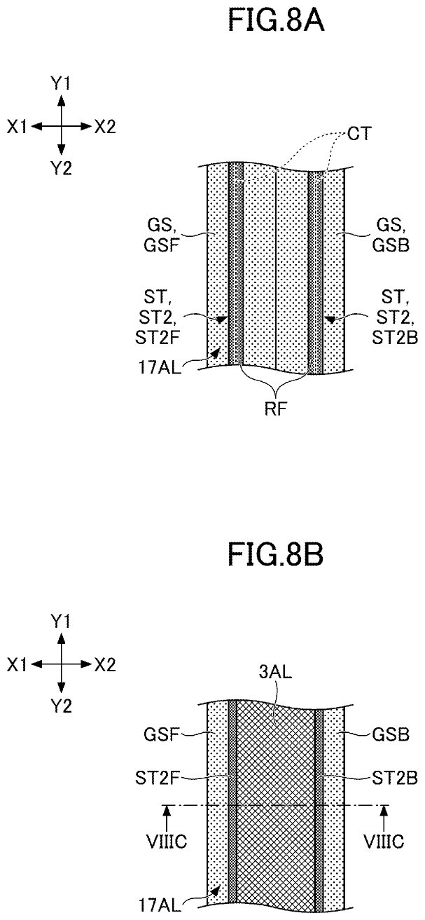

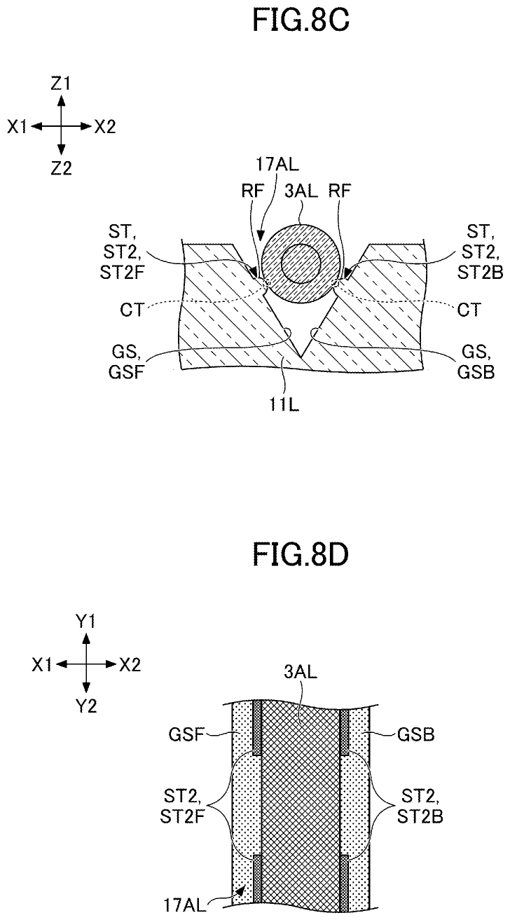

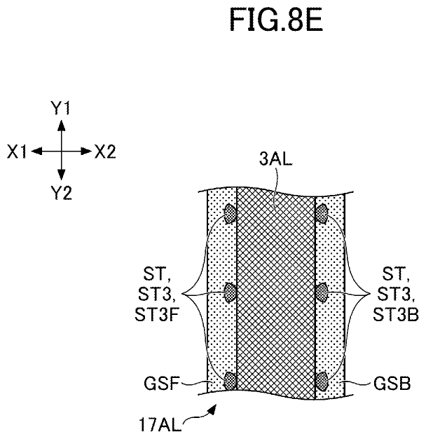

Next, a semicylindrical protrusion ST2, which is another configuration example of the stepped portion ST, will be described with reference to FIG. 8A through FIG. 8E. FIG. 8A through FIG. 8E are diagrams illustrating configuration examples of the first left V groove 17AL. In particular, FIG. 8A is a top view of the first left V groove 17AL before the first left optical fiber 3AL is provided. FIG. 8B is a top view of the first left V groove 17AL after the first left optical fiber 3AL is provided. FIG. 8C is a view of a cross section including a cutting plane line VIIIC-VIIIC in FIG. 8B viewed from the Y2 side as indicated by arrows. FIG. 8D is a top view of the first left V groove 17AL including the semicylindrical protrusion ST2, which is another configuration example of the stepped portion ST. FIG. 8E is a top view of the first left V groove 17AL including hemispherical protrusions ST3, which are still another configuration example of the stepped portions ST.

In FIG. 8A, FIG. 8B, FIG. 8D, and FIG. 8E, for the sake of clarity, coarse dot patterns are added to the groove surfaces GS, and fine dot patterns are added to the stepped portions ST formed on the groove surfaces GS. In addition, in FIG. 8B, FIG. 8D, and FIG. 8E, cross patterns are added to the first left optical fiber 3AL, for the sake of clarity. Moreover, in FIG. 8A and FIG. 8C, the contact portions CT where the first left optical fiber 3AL and the first left V groove 17AL make contact with each other are indicated by broken lines.

The following description with reference to FIG. 8A through FIG. 8E relates to the stepped portions ST (semicylindrical protrusions ST2 or hemispherical protrusions ST3) formed in the first left V groove 17AL, but the description is similarly applicable to the stepped portions ST formed in each of the second left V groove 17BL through the fourth left V groove 17DL, and the first right V groove 17AR through the fourth right V groove 17DR.

FIG. 8A through FIG. 8D illustrate the semicylindrical protrusion ST2, which is another example of the stepped portion ST. The semicylindrical protrusion ST2 includes a front semicylindrical protrusion ST2F formed on the front groove surface GSF of the first left V groove 17AL, and a rear semicylindrical protrusion ST2B formed on the rear groove surface GSB of the first left V groove 17AL.

The front semicylindrical protrusion ST2F has a semicircular cross section as illustrated in FIG. 8C, and is formed so as to continuously extend over the entire length of the first left V groove 17AL as illustrated in FIG. 8A. The same applies to the rear semicylindrical protrusion ST2B.

According to this configuration, the support surfaces RF, including the contact portions CT where the first left optical fiber 3AL and the semicylindrical protrusions ST2 make contact with one another, protrude from the groove surfaces GS, thereby achieving the effect of making it more difficult for the foreign matter to adhere to the support surfaces RF. This is because the surface area of the support surface RF is smaller than the surface area of the groove surface GS without the semicylindrical protrusion ST2.

The semicylindrical protrusions ST2 may be intermittently disposed along the axial direction of the first left V groove 17AL, as illustrated in FIG. 8D. According to this configuration, because the surface area of the support surface RF can further be reduced, it is possible to further reduce adhesion of the foreign matter onto the support surfaces RF.

FIG. 8E illustrates the hemispherical protrusion ST3, which is still another example of the stepped portion ST. The hemispherical protrusion ST3 includes a front hemispherical protrusion ST3F formed on the front groove surface GSF of the first left V groove 17AL, and a rear hemispherical protrusion ST3B formed on the rear groove surface GSB of the first left V groove 17AL. According to this configuration, because the surface area of the support surface RF can further be reduced, it is possible to further reduce adhesion of the foreign matter onto the support surfaces RF.

The semicylindrical protrusion ST2 is formed so as to have a semicircular cross section, as illustrated in FIG. 8C, however, the protrusion serving as the stepped portion ST may have other cross sectional shapes, such as a semioval shape, triangular shape, a rectangular shape, or the like.

Similarly, the hemispherical protrusion ST3 is formed so as to have a semicircular cross section, however, however, the protrusion serving as the stepped portion ST may have other cross sectional shapes, such as a semielliptical shape, triangular shape, a rectangular shape, or the like.

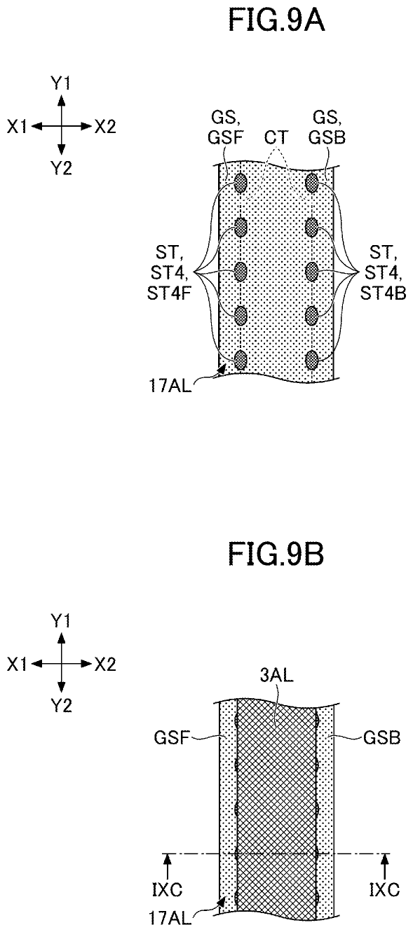

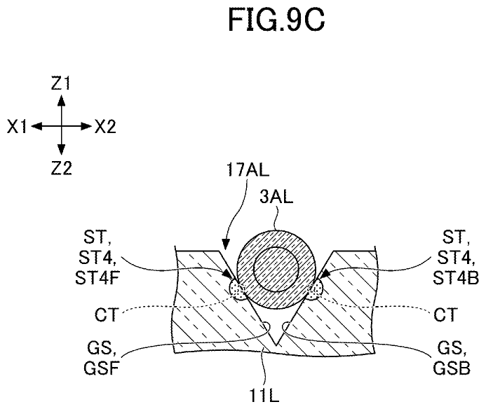

Next, a hemispherical hole ST4 will be described as another configuration example of the stepped portion ST, with reference to FIG. 9A through FIG. 9C. FIG. 9A through FIG. 9C are diagrams illustrating the configuration example of the first left V groove 17AL. In particular, FIG. 9A is a top view of the first left V groove 17AL before the first left optical fiber 3AL is provided. FIG. 9B is a top view of the first left V groove 17AL after the first left optical fiber 3AL is provided. FIG. 9C is a view of a cross section including a cutting plane line IXC-IXC in FIG. 9B viewed from the Y2 side as indicated by arrows.

In FIG. 9A and FIG. 9B, for the sake of clarity, coarse dot patterns are added to the groove surfaces GS, and fine dot patterns are added to the stepped portions ST (hemispherical holes ST4) formed in the groove surfaces GS. Moreover, in FIG. 9B, cross patterns are added to the first left optical fiber 3AL, for the sake of clarity. Further, in FIG. 9A and FIG. 9C, the contact portions CT where the first left optical fiber 3AL and the first left V groove 17AL make contact with each other are indicated by broken lines.

The following description with reference to FIG. 9A through FIG. 9C relates to the stepped portions ST (hemispherical holes ST4) formed in the first left V groove 17AL, but the description is similarly applicable to the stepped portions ST formed in the second left V groove 17BL through the fourth left V groove 17DL, and the first right V groove 17AR through the fourth right V groove 17DR.

FIG. 9A through FIG. 9C illustrate the hemispherical hole ST4, which is an example of the stepped portion ST. The hemispherical hole ST4 includes a front hemispherical hole ST4F formed in the front groove surface GSF of the first left V groove 17AL, and a rear hemispherical hole ST4B formed in the rear groove surface GSB of the first left V groove 17AL.

As illustrated in FIG. 9C, the front hemispherical holes ST4F are recesses formed in the front groove surface GSF so as to oppose the first left optical fibers 3AL disposed inside the first left V groove 17AL, and as illustrated in FIG. 9A, the front hemispherical holes ST4F are arranged at equal intervals along the extending direction (Y-axis direction) of the first left V groove 17AL. The same applies to the rear hemispherical holes ST4B. However, both the front hemispherical holes ST4F and the rear hemispherical holes ST4B may be arranged at unequal intervals. In addition, although the front hemispherical holes ST4F and the rear hemispherical holes ST4B are disposed so as to oppose each other in the X-axis direction in the example illustrated in FIG. 9A, the front hemispherical holes ST4F and the rear hemispherical holes ST4B may be disposed so as not to oppose each other in the X-axis direction.

According to this configuration, the surface area of the contact portion CT where the first left optical fiber 3AL and the groove surface GS of the first left V groove 17AL make contact with each other is smaller than that of the groove surface GS without the hemispherical hole ST4, thereby achieving the effect of making it more difficult for the foreign matter to adhere to the contact portions CT.

Although the hemispherical hole ST4 is formed to have the semicircular cross section, as illustrated in FIG. 9C, the hole serving as the stepped portion ST may have other cross sectional shapes, such as a semielliptical shape, a triangular shape, a rectangular shape, or the like.

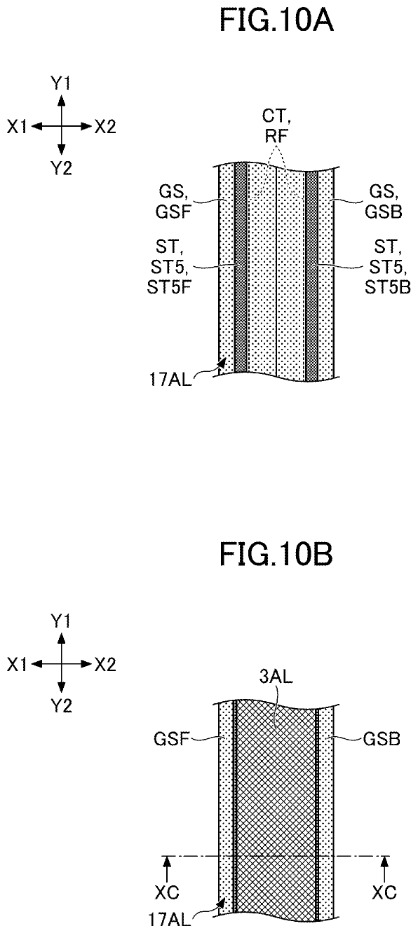

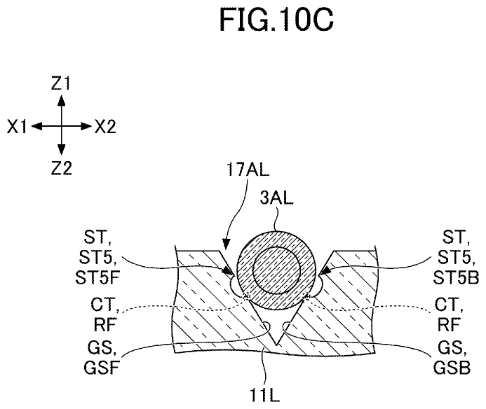

Next, a semicylindrical hole ST5, which is still another configuration example of the stepped portion ST, will be described with reference to FIG. 10A through FIG. 10C. FIG. 10A through FIG. 10C are diagrams illustrating a configuration example of the first left V groove 17AL. In particular, FIG. 10A is a top view of the first left V groove 17AL before the first left optical fiber 3AL is provided. FIG. 10B is a top view of the first left V groove 17AL after the first left optical fiber 3AL is provided. FIG. 10C is a view of a cross section including a cutting plane line XC-XC in FIG. 10B viewed from the Y2 side as indicated by arrows.

In FIG. 10A and FIG. 10B, for the sake of clarity, coarse dot patterns are added to the groove surfaces GS, and fine dot patterns are added to the stepped portions ST (semicylindrical holes ST5) formed in the groove surfaces GS. In addition, in FIG. 10B, cross patterns are added to the first left optical fiber 3AL, for the sake of clarity. Moreover, in FIG. 10A and FIG. 10C, the contact portions CT where the first left optical fiber 3AL and the first left V groove 17AL make contact with each other are indicated by broken lines. Further, in the example illustrated in FIG. 10A through FIG. 10C, the contact portions CT form the support surfaces RF.

The following description with reference to FIG. 10A through FIG. 10C relates to the stepped portions ST (semicylindrical holes ST5) formed in the first left V groove 17AL, but the description is similarly applicable to the stepped portions ST formed in each of the second left V groove 17BL through the fourth left V groove 17DL, and the first right V groove 17AR through the fourth right V groove 17DR.

FIG. 10A through FIG. 10C illustrate the semicylindrical hole ST5 as an example of the stepped portion ST. The semicylindrical hole ST5 includes a front semicylindrical hole ST5F formed in the front groove surface GSF of the first left V groove 17AL, and a rear semicylindrical hole ST5B formed in the rear groove surface GSB of the first left V groove 17AL.

The front side semicylindrical hole ST5F is a recess formed in the front groove surface GSF so as to oppose the first left optical fiber 3AL provided in the first left V groove 17AL as illustrated in FIG. 10C, and is formed so as to continuously extend over the entire length of the first left V groove 17AL as illustrated in FIG. 10A. The same applies to the rear semicylindrical hole ST5B.

According to this configuration, the contact portions CT (support surfaces RF) where the first left optical fiber 3AL and the semicylindrical holes ST5 make contact with one another are limited to edge portions of the semicylindrical holes ST5. This is because the surface area of the contact portion CT (support surface RF) is smaller than the surface area of the groove surface GS without the semicylindrical hole ST5.

Although the semicylindrical hole ST5 is formed to have a semicircular cross section as illustrated in FIG. 10C, the hole serving as the stepped portion ST may be formed to have other cross sectional shapes, such as a semielliptical shape, a triangular shape, a rectangular shape, or the like.

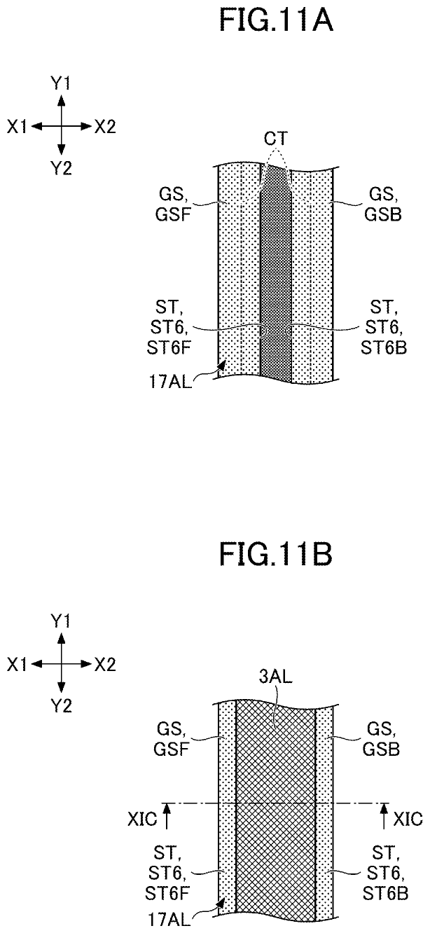

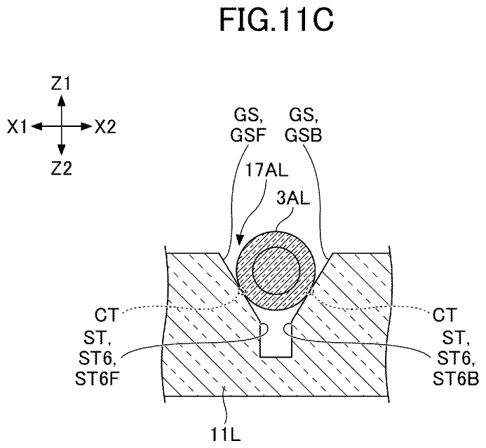

Next, a recess ST6, which is still another configuration example of the stepped portion ST, will be described with reference to FIG. 11A through FIG. 11C. FIG. 11A through FIG. 11C are diagrams illustrating a configuration example of the first left V groove 17AL. In particular, FIG. 11A is a top view of the first left V groove 17AL before the first left optical fiber 3AL is provided. FIG. 11B is a top view of the first left V groove 17AL after the first left optical fiber 3AL is provided. FIG. 11C is a view of a cross section including a cutting plane line XIC-XIC in FIG. 11B viewed from the Y2 side as indicated by arrows.

In FIG. 11A and FIG. 11B, coarse dot patterns are added to the groove surfaces GS for the sake of clarity. In addition, in FIG. 11A, for the sake of clarity, fine dot patterns are added to the stepped portions ST (recesses ST6) formed in the groove surfaces GS. Moreover, in FIG. 11B, cross patterns are added to the first left optical fiber 3AL, for the sake of clarity. Further, in FIG. 11A and FIG. 11C, the contact portions CT where the first left optical fiber 3AL and the first left V groove 17AL make contact with each other are indicated by broken lines.

The following description with reference to FIG. 11A through FIG. 11C relates to the stepped portions ST (recesses ST6) formed in the first left V groove 17AL, but the description is similarly applicable to the stepped portions ST formed in each of the second left V groove 17BL through the fourth left V groove 17DL, and the first right V groove 17AR through the fourth right V groove 17DR.

FIG. 11A to FIG. 11C illustrate the recess ST6 as an example of the stepped portion ST. The recess ST6 is a portion capable of temporarily storing foreign matter, and includes a front recess ST6F formed in the front groove surface GSF of the first left V groove 17AL, and a rear recess ST6B formed in the rear groove surface GSB of the first left V groove 17AL.

As illustrated in FIG. 11C, the front recess ST6F is a portion of the recess provided in the bottom portion of the first left V groove 17AL, and as illustrated in FIG. 11A, the front recess ST6F is formed so as to continuously extend over the entire length of the first left V groove 17AL. The same applies to the rear recess ST6B.

According to this configuration, by increasing a volume of a space (space capable of receiving foreign matter) provided at the bottom portion of the first left V groove 17AL, it is possible to achieve the effect of reducing foreign matter deposited at the bottom portion of the first left V groove 17AL from coming into contact with the first left optical fiber 3AL. That is, this configuration can achieve the effect of reducing raising of the first left optical fiber 3AL caused by the foreign matter deposited at the bottom portion of the first left V groove 17AL. Further, this configuration can achieve the effect of reducing interference of the contact between the first left optical fiber 3AL and the first left V groove 17AL at the contact portions CT.

Although the recess ST6 is formed to have a rectangular cross section as illustrated in FIG. 11C, the recess ST6 may be formed to have other cross sectional shapes, such as a trapezoidal shape, a circular shape, an elliptical shape, or the like.

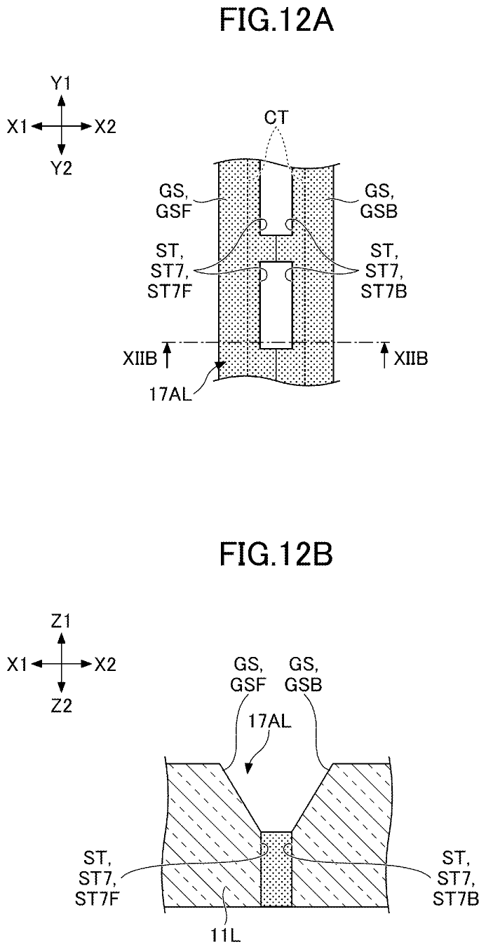

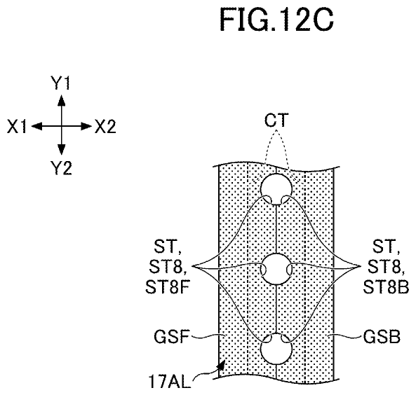

Next, a through hole ST7, which is still another configuration example of the stepped portion ST, will be described with reference to FIG. 12A through FIG. 12C. FIG. 12A through FIG. 12C are diagrams illustrating a configuration example of the first left V groove 17AL. In particular, FIG. 12A is a top view of the first left V groove 17AL before the first left optical fiber 3AL is provided. FIG. 12B is a view of a cross section including a cutting plane line XIIB-XIIB in FIG. 12A viewed from the Y2 side as indicated by arrows. FIG. 12C is a top view of the first left V groove 17AL including a circular through hole ST8 as another example of the through hole ST7.

In FIG. 12A and FIG. 12C, coarse dot patterns are added to the groove surfaces GS for the sake of clarity. In addition, in FIG. 12A and FIG. 12C, the contact portions CT where the first left optical fiber 3AL and the first left V groove 17AL make contact with each other are indicated by broken lines.

The following description with reference to FIG. 12A through FIG. 12C relates to the stepped portions ST (through holes ST7 or circular through holes ST8) formed in the first left V groove 17AL, but the description is similarly applicable to the stepped portions ST formed in each of the second left V groove 17BL through the fourth left V groove 17DL, and the first right V groove 17AR through the fourth right V groove 17DR.

FIG. 12A and FIG. 12B illustrate the through hole ST7 as still another example of the stepped portion ST. The through hole ST7 includes a front recess ST7F formed in the front groove surface GSF of the first left V groove 17AL, and a rear recess ST7B formed in the rear groove surface GSB of the first left V groove 17AL.

As illustrated in FIG. 12B, the front recess ST7F is a portion of a rectangular through hole provided in the bottom portion of the first left V groove 17AL, and as illustrated in FIG. 12A, the front recesses ST7F are formed so as to be arranged intermittently over the entire length of the first left V groove 17AL. The same applies to the rear recess ST7B. In addition, in the example illustrated in FIG. 12A, the through holes ST7 are arranged at equal intervals along the extending direction (Y-axis direction) of the first left V groove 17AL. However, the through holes ST7 may be arranged at unequal intervals.

According to this configuration, by providing the through hole ST7 in the bottom portion of the first left V groove 17AL, it is possible to achieve the effect of reducing or preventing foreign matter from being deposited in the first left V groove 17AL. That is, this configuration can achieve the effect of preventing the foreign matter from being accumulated in the first left V groove 17AL. For this reason, this configuration can achieve the effect of reducing raising of the first left optical fiber 3AL caused by the foreign matter deposited in the first left V groove 17AL. Further, this configuration can achieve the effect of reducing or preventing interference of the contact between the first left optical fiber 3AL and the first left V groove 17AL at the contact portions CT. Hence, this configuration can reduce the frequency with which the position of the optical fiber provided in the V groove deviates from a predetermined position due to the foreign matter, and as a result, it is possible to reduce the additional work required to remove the foreign matter.

FIG. 12C illustrates the circular through hole ST8 as an example of the stepped portion ST. The circular through hole ST8 includes a front recess ST8F formed in the front groove surface GSF of the first left V groove 17AL, and a rear recess ST8B formed in the rear groove surface GSB of the first left V groove 17AL.

The front recess ST8F is a portion of the circular through hole ST8 provided in the bottom portion of the first left V groove 17AL, and the front recesses ST8F are formed so as to be arranged intermittently over the entire length of the first left V groove 17AL as illustrated in FIG. 12C. The same applies to the rear recesses ST8B. In addition, in the example illustrated in FIG. 12C, the circular through holes ST8 are arranged at equal intervals along the extending direction (the Y-axis direction) of the first left V groove 17AL. However, the circular through holes ST8 may be arranged at unequal intervals.

According to this configuration, by providing the circular through hole ST8 in the bottom portion of the first left V groove 17AL, it is possible to achieve the effect of reducing or preventing foreign matter from being deposited in the first left V groove 17AL. That is, this configuration can achieve the effect of reducing raising of the first left optical fiber 3AL caused by the foreign matter deposited in the first left V groove 17AL. Further, this configuration can achieve the effect of reducing or preventing interference of the contact between the first left optical fiber 3AL and the first left V groove 17AL at the contact portions CT. Hence, this configuration can reduce the frequency with which the position of the optical fiber provided in the V groove deviates from a predetermined position due to the foreign matter, and as a result, it is possible to reduce the additional work required to remove the foreign matter.

As described above, the fusion splicer 1 according to one embodiment of the present disclosure is configured to be able to fusion splice the first left optical fiber 3AL. In addition, the fusion splicer 1 includes the left base member 11L having the first left V groove 17AL in which the first left optical fiber 3AL is provided. Moreover, inclined surfaces (groove surfaces GS) of the first left V groove 17AL are provided with stepped portions ST (refer to the presser guides ST1 in FIG. 6A or FIG. 6D, the semicylindrical protrusions ST2 in FIG. 8A or FIG. 8D, the hemispherical protrusions ST3 in FIG. 8E, the hemispherical holes ST4 in FIG. 9A, or the semicylindrical holes ST5 in FIG. 10A), and the stepped portions ST are provided at positions making contact with the first left optical fiber 3AL.

In this configuration, by reducing the surface area of the support surface RF including the contact portion CT, which is the portion of the groove surface GS of the first left V groove 17AL making contact with the first left optical fiber 3AL, it is possible to reduce a probability of foreign matter adhering to the contact portion CT. For this reason, this configuration can achieve the effect of reducing foreign matter becoming caught between the first left optical fiber 3AL and the first left V groove 17AL when providing the first left optical fiber 3AL in the first left V groove 17AL. Further, this configuration can achieve the effect of accurately positioning the first left optical fiber 3AL inside the first left V groove 17AL.

In addition, the support surfaces RF are typically configured to have a surface roughness smaller (finer) than a surface roughness of other portions of the groove surfaces GS, so that the first left optical fiber 3AL is positioned inside the first left V groove 17AL with a high accuracy. For this reason, the foreign matter adhered to the support surfaces RF may not peel off easily. The foreign matter is a substance (glass, coating material residue, or the like) that is evaporated and vaporized by the arc discharge during a previous fusion splicing, and thereafter solidified, for example.

On the other hand, the fusion splicer 1 according to one embodiment of the present disclosure can reduce or prevent the foreign matter from adhering to the support surfaces RF for the reasons described above. For this reason, the fusion splicer 1 can achieve the effect of simplifying or omitting cleaning of the first left optical fiber 3AL before the fusion splicing, for example. Similarly, the fusion splicer 1 can achieve the effect of simplifying or omitting cleaning of the first left V groove 17AL before the fusion splicing, for example. In addition, the fusion splicer 1 can achieve the effect of reducing or preventing damage to the first left V groove 17AL during the cleaning of the first left V groove 17AL.

The groove surfaces GS that do not contribute to the positioning accuracy of the first left optical fiber 3AL may be formed to have a surface roughness larger (coarser) than the surface roughness of the support surfaces RF. This is to enable forming of the groove surfaces GS at a low cost. Further, this is to make it more difficult for the foreign matter to adhere to the groove surfaces GS.

The stepped portions ST may be the recesses ST6 provided at the bottom portion of the first left V groove 17AL as illustrated from FIG. 11A through FIG. 11C, or may be the through holes ST7 penetrating the left base member 11L as illustrated in FIG. 12A and FIG. 12B. Alternatively, the stepped portion ST may be the circular through holes ST8 penetrating the left base member 11L as illustrated in FIG. 12C.

Because this configuration can reduce the accumulation of the foreign matter in the first left V groove 17AL, it is possible to achieve the effect of reducing or preventing the raising of the first left optical fiber 3AL by the foreign matter accumulated in the first left V groove 17AL. In addition, this configuration can achieve the effect of reducing the foreign matter becoming caught between the first left optical fiber 3AL and the first left V groove 17AL when providing the first left optical fiber 3AL in the first left V groove 17AL. Further, this configuration can achieve the effect of accurately positioning the first left optical fiber 3AL inside the first left V groove 17AL. Hence, this configuration can reduce the frequency with which the position of the optical fiber provided in the V groove deviates from a predetermined position due to the foreign matter, and as a result, it is possible to reduce the additional work required to remove the foreign matter.

The stepped portion ST may be provided in at least one of the plurality of V grooves (the first left V groove 17AL through the fourth left V groove 17DL). That is, the stepped portion ST may be provided in all of the plurality of V grooves, or may be provided in only some of the plurality of V grooves.

The V groove cleaning jig 70 used for cleaning the V groove in the fusion splicer 1 according to one embodiment of the present disclosure includes the sliding surfaces 71 (the central sliding surface 71 MB and the central sliding surfaces 71MF) making contact with the support surfaces RF (refer to FIG. 6B) that form portions of the inclined surfaces (groove surfaces GS in FIG. 6B) of the first left V groove 17AL, as illustrated in FIG. 7B, and the V groove cleaning jig 70 is configured to be slidable in the extending direction (Y-axis direction) of the first left V groove 17AL in a state where the support surfaces RF and the sliding surfaces 71 make contact with one another.

The V groove cleaning jig 70 can scrape off the foreign matter adhered to the support surfaces RF, from the support surfaces RF before the first left optical fiber 3AL is provided in the first left V groove 17AL. For this reason, it is possible to achieve the effect of reducing foreign matter becoming caught between the first left optical fiber 3AL and the first left V groove 17AL when providing the first left optical fiber 3AL in the first left V groove 17AL. it is possible to achieve the effect of accurately positioning the first left optical fiber 3AL in the first left V groove 17AL.

Preferred embodiments of the present disclosure are described above in detail. However, the disclosed embodiments are to be considered in all respects as illustrative and not restrictive. The scope of the present invention as defined by the appended claims is not limited to the foregoing description, and is intended to include all modifications within the scope and meaning equivalent to the appended claims. That is, the present invention is not limited to the embodiments described above. Various modifications, substitutions, or the like can be made to the embodiments described above without departing from the scope of the present invention. In addition, each of the features described with reference to the embodiments described above may be appropriately combined as long as there is technically no contradiction.

For example, in the embodiments described above, the fusion splicer 1 includes the left base member 11L formed with the plurality of V grooves, and the right base member 11R formed with the plurality of V grooves. However, the fusion splicer 1 may include the left base member 11L formed with only a single V groove, and the right base member 11R formed with only a single V groove. Further, each single V groove may be provided with the stepped portion ST. That is, the fusion splicer 1 may be a device for fusion splicing single-core optical fiber.

Further, the shape of the jig 70 illustrated in FIG. 7A through FIG. 7D is configured to match the shape of the V groove illustrated in FIG. 6B, but the shape of the jig 70 may be configured to match the shape of other V grooves, such as the V grooves illustrated in FIG. 8C, FIG. 10C, FIG. 11C, or the like.

### DESCRIPTION OF REFERENCE NUMERALS

1: Fusion splicer
3: Optical fiber group
3A: First optical fiber pair
3AL: First left optical fiber
3AR: First right optical fiber
3B: Second optical fiber pair
3BL: Second left optical fiber
3BR: Second right optical fiber
3C: Third optical fiber pair
3CL: Third left optical fiber
3CR: Third right optical fiber
3D: Fourth optical fiber pair
3DL: Fourth left optical fiber
3DR: Fourth right optical fiber
3L: Left optical fiber group
3R: Right optical fiber group
4L: Left optical fiber ribbon
4R: Right optical fiber ribbon
5: Electrode
5B: Rear electrode
5Ba: Tip end
5F: Front electrode
5Fa: Tip end
11: Base member
11L: Left base member
11R: Right base member
17: V groove group
17A: First V groove pair
17AL: First left V groove
17AR: First right V groove
17B: Second V groove pair
17BL: Second left V groove
17BR: Second right V groove
17C: Third V groove pair
17CL: Third left V groove
17CR: Third right V groove
17D: Fourth V groove pair
17DL: Fourth left V groove
17DR: Fourth right V groove
17L: Left V groove group
17R: Right V groove group
21: Clamp
21L: Left clamp
21La: Left arm portion
21Lb: Left pressing portion
21R: Right clamp
21Ra: Right arm portion
21Rb: Right pressing portion
31: Fiber holder
31L: Left fiber holder
31La: Left fiber holder main body
31Lb: Left lid
31R: Right fiber holder
31Ra: Right fiber holder main body
31Rb: Right lid
51: Imaging device
52: Fusion splicing device
53: Clamp driving device
54: Fiber holder driving device
55: Display device
60: Controller
70: Jig
71: Sliding surface
71B: Rear sliding surface
71DB, 71DF: Lower sliding surface
71E: Tip end portion
71F: Front sliding surface
71G: Tip end portion
71MB, 71MF: Central sliding surface
71S: Bottom surface
71UB, 71UF: Upper sliding surface
CT: Contact portion
GS: Groove surface
GSB: Rear groove surface
GSF: Front groove surface
HD: Gripping portion
RF: Support surface
ST: Stepped portion
ST1: Presser guide
ST1B: Rear presser guide
ST1F: Front presser guide
ST2: Semicylindrical protrusion
ST2B: Rear semicylindrical protrusion
ST2F: Front semicylindrical protrusion
ST3: Hemispherical protrusion
ST3B: Rear hemispherical protrusion
ST3F: Front hemispherical protrusion
ST4: Hemispherical hole
ST4B: Rear hemispherical hole
ST4F: Front hemispherical hole
ST5: Semicylindrical hole
ST5B: Rear semicylindrical hole
ST5F: Front semicylindrical hole
ST6: Recess
ST6B: Rear recess
ST6F: Front recess
ST7: Through hole
ST7B: Rear recess
ST7F: Front recess
ST8: Circular through hole
ST8B: Rear recess
ST8F: Front recess

1. A fusion splicer for fusion splicing an optical fiber, comprising:
a base member having a V groove in which the optical fiber is provided, wherein
a stepped portion is provided on an inclined surface of the V groove, and
the stepped portion is provided at a position making contact with the optical fiber.

2. A fusion splicer for fusion splicing an optical fiber, comprising:
a base member having a V groove in which the optical fiber is provided, wherein
a stepped portion is provided on an inclined surface of the V groove, and
the stepped portion is a recess provided at a bottom portion of the V groove.

3. The fusion splicer as claimed in claim 2, wherein the stepped portion is a through hole penetrating the base member.

4. The fusion splicer as claimed in claim 1, wherein
the optical fiber is included in a plurality of optical fibers,
the V groove is included in a plurality of V grooves in which the plurality of optical fibers are provided, and
the stepped portion is provided in at least one of the plurality of V grooves.

5. A V groove cleaning jig used for cleaning the V groove in the fusion splicer according to claim 1, comprising:
a sliding surface that forms a part of the inclined surface and makes contact with a supporting surface supporting the optical fiber,
wherein the V groove cleaning jig is slidable in an extending direction of the V groove in a state where the supporting surface and the sliding surface make contact with each other.

6. The fusion splicer as claimed in claim 2, wherein
the optical fiber is included in a plurality of optical fibers,
the V groove is included in a plurality of V grooves in which the plurality of optical fibers are provided, and
the stepped portion is provided in at least one of the plurality of V grooves.

7. A V groove cleaning jig used for cleaning the V groove in the fusion splicer according to claim 2, comprising:
a sliding surface that forms a part of the inclined surface and makes contact with a supporting surface supporting the optical fiber,
wherein the V groove cleaning jig is slidable in an extending direction of the V groove in a state where the supporting surface and the sliding surface make contact with each other.
